(19) United States
(12) Patent Application Publication
(10) Pub. No.: US 2020/0189609 A1
(43) Pub. Date: Jun. 18, 2020

(54) SMART VEHICLE SYSTEM

(71) Applicant: SK hynix Inc., Icheon-si (KR)

(72) Inventor: Hyeng Ouk LEE, Yongin-si (KR)

(21) Appl. No.: 16/382,130

(22) Filed: Apr. 11, 2019

(30) Foreign Application Priority Data
Dec. 14, 2018 (KR) 10-2018-0161534

(51) Int. Cl. B60W 50/029; B60W 50/04

(52) U.S. Cl. CPC B60W 50/029; B60W 50/045; B60W 2050/046; B60W 2050/041; B60W 2050/0297

(57) ABSTRACT

A smart vehicle system, which relates to technology for improving driving stability, safety and reliability of a vehicle when an error occurs in operational reliability of the vehicle. The smart vehicle system includes a host configured to receive a communication state information, store the received communication state information, and transmit a priority information of a communicable interface in response to the communication state information, a controller configured to select the communicable interface in response to the priority information, when a fault in the storage device is detected, and a communication interface circuit configured to include a plurality of communicable interfaces and to communicate with an external electronic device through the communicable interface selected by the controller.

### CROSS-REFERENCE TO RELATED APPLICATION

This application claims priority to Korean patent application No. 10-2018-0161534, filed on Dec. 14, 2018, the disclosure of which is herein incorporated by reference in its entirety.

### BACKGROUND OF THE INVENTION

### 1. Technical Field

Embodiments of the present disclosure may generally relate to a smart vehicle and methods of operating a smart vehicle and a smart vehicle system, and more particularly to a smart vehicle system with technology for improving operational stability, safety, and reliability of a vehicle when an error occurs in vehicle or during vehicle operation.

### 2. Related Art

Recently, as various mobile communication devices, such as smartphones, tablets, etc. for example, have been widely used throughout the world, the demand for information technology (IT) convergence and for the unification of digital information across devices and platforms has increased. For example, demand for infotainment, telematics, etc. within vehicles is rapidly increasing. Therefore, many developers and companies have focused attention on smart vehicle technology for providing drivers and passengers with higher safety, reliability and comfort through the use of information communication technology available to vehicle industries.

As a non-limiting example of a vehicle, a smart vehicle may refer to a car, truck or an automobile to which various Information and Communication Technologies (ICT) are applied and/or installed. The smart vehicle may combine or collect various kinds of in-vehicle information, may manage the unified in-vehicle information, and may provide drivers and passengers with various content and data, for example, entertainment-related content, information content, convenience-related content, etc.

The smart vehicle has been developed by combining traditional mechanical-based vehicle technology with modern technologies, for example, next-generation electrical and electronics technologies, information communication technologies, intelligence control technologies, artificial intelligence technologies, etc. Therefore, the smart vehicle is able to collect, in real time, information about devices peripheral or external to the vehicle as well as information about in-vehicle devices, so that such information can increase operational reliability and stability of the smart vehicle. In addition, the smart vehicle includes various convenience-related functions and operations that can be augmented with the information, resulting in an increase in user satisfaction or comfort.

The smart vehicle, or any other vehicle, may store in-vehicle information in a storage device such as a memory, and may control the vehicle operation in response to or using information stored in the storage device. However, if an error occurs that affects the reliable operation of the vehicle, such as a faulty or defective operation related to the storage device embedded in the smart vehicle, driving reliability, safety and stability of the smart vehicle cannot be guaranteed.

### BRIEF SUMMARY OF THE INVENTION

Various embodiments of the present disclosure are directed to providing a smart vehicle system in a vehicle that substantially obviates one or more problems due to limitations and disadvantages of the related art.

The embodiments of the present disclosure relate to a smart vehicle with a smart vehicle system for increasing operational safety, reliability and stability of a smart vehicle using a memory of an external electronic device when an error occurs in a storage device of the smart vehicle, as well as methods of operation. Although embodiments herein are described with respect to a smart vehicle, it will be understood that the scope of the present disclosure is not limited thereto, and includes other smart vehicles known to those having ordinary skill in the art.

In accordance with an embodiment of the present disclosure, a smart vehicle system includes a storage device, a host configured to receive a communication state information, store the received communication state information, and transmit a priority information of a communicable interfaces in response to the communication state information, a controller configured to select the communicable interface in response to the priority information, when a fault in the storage device is detected, and a communication interface circuit configured to include a plurality of communicable interface, and to communicate with an external electronic device through the communicable interface selected by the controller. The controller may receive a resource information from the external electronic device through the communication interface circuit, may store the received resource information, and may control an operation of a smart vehicle using the stored resource information.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The above and other features and advantages of the present disclosure will become readily apparent by reference to the following detailed description when considered in conjunction with the accompanying drawings wherein:

FIG. 1 is a block diagram illustrating an example of a smart vehicle system according to an embodiment of the present disclosure.

FIG. 2 is a block diagram illustrating an example of a controller shown in FIG. 1 according to an embodiment of the present disclosure.

FIG. 3 is a block diagram illustrating a communication interface circuit shown in FIG. 1 according to an embodiment of the present disclosure.

FIG. 4 is a flowchart illustrating method of operating a smart vehicle system shown in FIG. 1 according to embodiments of the present disclosure.

### DESCRIPTION OF EMBODIMENTS

Reference will now be made in detail to embodiments of the present disclosure, examples of which are illustrated in the accompanying drawings. Wherever possible, the same reference numbers are used throughout the drawings to refer to the same or like portions. Throughout the specification of the present disclosure, if it is assumed that a certain part is connected (or coupled) to another part, then the term “connection or coupling” means that the certain part is directly connected (or coupled) to another part and/or is electrically connected (or coupled) to another part through another medium. Throughout the specification of the present disclosure, if it is assumed that a certain part includes a certain component, then the term “comprising”, “having” or “including” means that a corresponding component may further include other components unless a specific meaning opposed to the corresponding component is written. As used in the specification and appended claims, the terms “a”, “an”, “one”, “the” and other similar terms include both singular and plural forms, unless context clearly dictates otherwise. The terms used in the present application are merely used to describe specific embodiments and are not intended to limit the present disclosure. A singular expression may include a plural expression unless otherwise stated in the context.

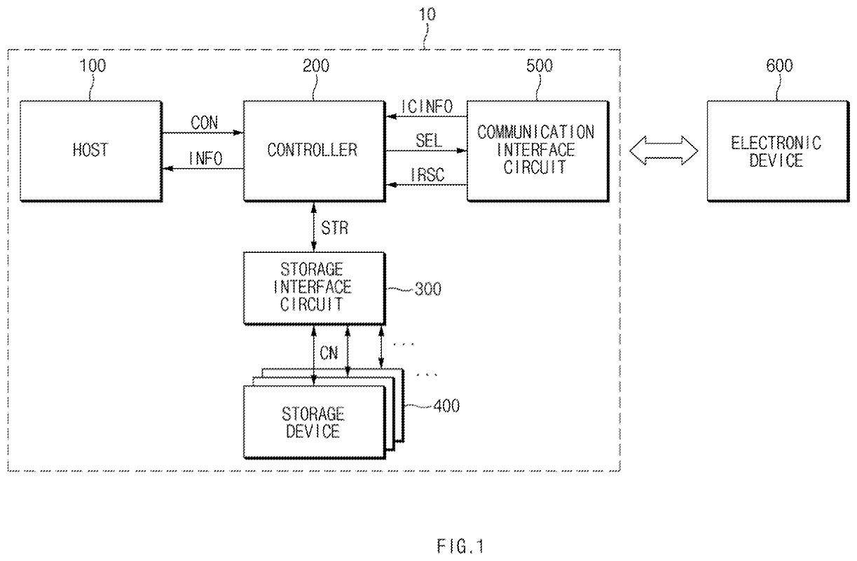

FIG. 1 is a block diagram illustrating a smart vehicle system 10 according to an embodiment of the present disclosure.

Referring to FIG. 1, a smart vehicle includes the smart vehicle system 10, which may include a host 100, a controller 200, a storage interface circuit 300, a storage device 400, and a communication interface circuit 500.

In this case, the host 100 may store information INFO received from the controller 200. The host 100 may generate a control signal CON, used to operate the controller 200, and transmit the generated control signal CON to the controller 200.

In accordance with an embodiment, the host 100 may be implemented as a board such as a Printed Circuit Board (PCB). Although not shown in FIG. 1, the host 100 may include a plurality of functional blocks needed to generate and process a control signal CON. The host 100 may include a connection terminal (not shown) to transmit and receive signals to and from the controller 200, such as a socket, a slot, or a connector as non-limiting examples. Through the connection terminal, various kinds of information (for example, commands, address, data, signals, etc.) may be communicated between the host 100 and the controller 200. The connection terminal may be constructed in various ways according to known interface schemes between the host 100 and the controller 200.

The host 100 may receive information about a communication state of the communication interface circuit 500 from the controller 200. The host 100 may store the received communication state information, which relates to the communication interface circuit 500 and communicable interfaces common to various electronic devices 600. The host 100 may allocate a priority information for a communicable interface from among a plurality of communicable interfaces on the basis of the received communication state information. The host 100 may transmit the priority information of the communicable interface to the controller 200.

The controller 200 may control overall operation of the smart vehicle system 10. The controller 200 may operate in response to the control signal CON received from the host 100.

For example, after receiving the control signal CON from the host 100, the controller 200 may control background functional blocks using firmware or software needed to drive or operate the smart vehicle system 10. The controller 200 may process operations of the smart vehicle system 10 in response to the control signal CON received from the host 100. The controller 200 may transmit a response signal corresponding to the processed result to the host 100. The controller 200 may store data received from the host 100. The controller may read stored information and transmit the read information INFO to the host 100.

The controller 200 may receive information STR about the storage device 400 through the storage interface circuit 300. The controller 200 may receive information STR about the storage device 400, may test a state of the storage device 400, and may detect occurrence or non-occurrence of a faulty operation in the storage device 400. If the controller 200 determines that a faulty operation has occurred in the storage device 400 by referring to the result of testing of the state of the storage device 400, the controller 200 may select any one of communicable interfaces contained in the communication interface circuit 500. The smart vehicle system 10, therefore, may communicate with external electronic devices 600 through the selected communicable interface.

The communication interface circuit 500 may transmit to the controller 200 a communication state information ICINFO, which informs a communication state between the communication interface circuit 500 and one or more external electronic devices 600.The controller 200 may generate a selection signal SEL used to select any one of a plurality of communicable interfaces in the communication interface circuit 500. Upon receiving a communication state information ICINFO from the communication interface circuit 500, the controller 200 may transmit the information INFO to the host 100. After receiving resource information IRSC of the selected electronic device 600 from the communication interface circuit 500, the controller 200 may store the received resource information IRSC, and may control operations of the smart vehicle system 10 using the stored resource information IRSC.

The storage interface circuit 300 may write data in the storage device 400 under control of the controller 200, or may read data stored in the storage device 400 under control of the controller 200. The storage interface circuit 300 may provide the controller 200 with information STR about the storage device 400 received through a channel CN. In this case, the storage interface circuit 300 may include a buffer allocation unit (BAU) configured to manage at least one buffer, such that the storage interface circuit 300 may manage usage and release of a buffer in the storage device 400.

The storage device 400 may be used as a storage medium of the smart vehicle system 10. The storage device 400 may store internal information of the smart vehicle system 10, and may transmit stored information to the controller 200 through storage interface circuit 300 after a request from the controller 200. The storage device 400 need not be limited to a single device. A plurality of storage devices may be used, and the plurality of storage devices may be coupled to the storage interface circuit 300 through a plurality of respective channels CN. In some embodiments, the storage device 400 may be implemented as a volatile memory, a non-volatile memory, or the like.

According to some embodiments of the present disclosure, the storage device 400, a storage medium for storing information, may be implemented as a volatile memory, a non-volatile memory, or the like, for example, for convenience of description and better understanding of the present disclosure. However, the scope or spirit of the storage device 400 is not limited thereto.

For example, the storage device 400 according to other embodiments of the present disclosure may include various non-volatile memory devices such as an Electrically Erasable and Programmable ROM (EEPROM), a NAND flash memory, a NOR flash memory, a Phase-Change RAM (PRAM), a Resistive RAM (ReRAM), a Ferroelectric RAM (FRAM), and a Spin Torque Transfer Magnetic RAM (STT-MRAM), as non-limiting examples.

The storage device 400 according to yet other embodiments of the present disclosure may be implemented as any one of various storage devices such as a Solid State Drive (SSD), a Multi Media Card (MMC), an Embedded MMC (eMMC), a Reduced Size MMC (RS-MMC), a micro-MMC, a Secure Digital (SD) card, a mini Secure Digital (mini-SD) card, a micro Secure Digital (micro-SD) card, a Universal Serial Bus (USB) memory, a Universal Flash Storage (UFS) device, a Personal Computer Memory Card International Association (PCMCIA) card-type memory, a Peripheral Component Interconnection (PCI) card-type memory, a PCI-express (PCI-E) card-type memory, a Compact Flash (CF) card, a Smart Media (SM) card, and a memory stick, by way of non-limiting examples.

In addition, the storage device 400 according to further embodiments of the present disclosure may be implemented as any one of various kinds of packages, such as a Package On Package (POP), a

System In Package (SIP), a System On Chip (SOC), a Multi-Chip Package (MCP), a Chip On Board (COB), a wafer-level fabricated package (WFP), and a wafer-level stack package (WSP), as non-limiting examples.

The communication interface circuit 500 may communicate with an external electronic device 600 in response to a communication request received from the controller 200. The communication interface circuit 500 may transmit communication state information ICINFO related to the external electronic device 600 to the controller 200.

The communication interface circuit 500 may include various types of communicable interfaces, each corresponding to an electronic device 600. The communication interface circuit 500 may communicate with an external electronic device 600 through the communicable interface selected or identified by the selection signal SEL of the controller 200 from among a plurality of different types of communicable interfaces associated with electronic devices 600. The communication interface circuit 500 may receive resource information IRSC from the selected electronic device 600, and may transmit the received resource information IRSC to the controller 200.

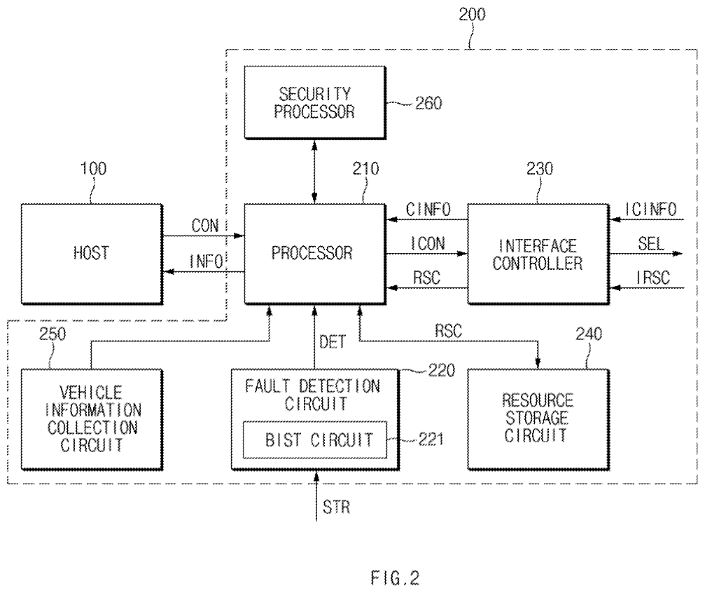

FIG. 2 is a block diagram illustrating the controller 200 shown in FIG. 1 according to an embodiment of the present disclosure.

Referring to FIG. 2, the controller 200 may include a processor 210, a fault detection circuit 220, an interface controller 230, a resource storage circuit 240, a vehicle information collection circuit 250, and a security processor 260.

The processor 210 may receive communication state information CINFO from the interface controller 230. The processor 210 may store the received information, and may transmit the stored information INFO to the host 100. The processor 210 may receive a control signal CON including one or more priority information of one or more communicable interfaces associated with electronic devices 600 from the host 100. The processor 210 may store priority information received from the host 100.

The processor 210 may designate, identify or select any one or more of the plurality of communicable interfaces contained in the communication interface circuit 500 in response to priority information. The processor 210 may transmit an interface control signal ICON to the interface controller 230 after a detection signal DET of the fault detection circuit 220 is activated or generated.

Upon receiving a resource signal RSC from the interface controller 230, the processor 210 may store the resource signal RSC in the resource storage circuit 240. The processor 210 may use the resource signal RSC stored in the resource storage circuit 240 as resource information needed to control operation of the smart vehicle with smart vehicle system 10.

For example, the processor 210 may control operation of the smart vehicle system 10 using the resource signal RSC including the resource information IRSC received from the external electronic device 600 according to execution of firmware. In this case, firmware may refer to software, applications, etc. needed to generate or process data.

The fault detection circuit 220 may determine the presence or absence of a faulty operation in the storage device 400 contained in the smart vehicle system 10. That is, the storage device 400 may be a device for storing information such that storage information can be read out from the device as necessary. If an unexpected fault or error occurs in the storage device 400 or in accessing the information stored therein, the fault or error has a negative effect on the smart vehicle system 10 in derogation of the reliability, safety and/or stability of the vehicle or its operation.

The fault detection circuit 220 may be coupled to the storage device 400 through the storage interface circuit 300. Therefore, the fault detection circuit 220 may receive information STR about the storage device 400 through the storage interface circuit 300. The fault detection circuit 220 may determine the presence or absence of a faulty operation or error in the storage device 400 based on the information STR about the storage device 400. If a faulty operation or error has occurred in the storage device 400, then the fault detection circuit 220 may generate and transmit the detection signal DET.

The fault detection circuit 220 may test whether a faulty operation occurs in the storage device 400 using a Built-In Self-Test (BIST) circuit 221, which may identify the faulty operation or error in the storage device 400 as a hardware fault or a software error.

In addition, the interface controller 230 may receive communication state information ICINFO of a communicable interface capable of communicating with an external electronic device 600 from among the plurality of communicable interfaces contained in the communication interface circuit 500. The interface controller 230 may transmit communication state information CINFO to the processor 210.

The interface controller 230 may activate or generate a selection signal SEL to select a communicable interface corresponding to the interface control signal ICON. That is, the interface controller 230 may select any one communicable interface selected from among the plurality of communicable interfaces contained in the communication interface circuit 500 in response to the interface control signal ICON, and may couple the selected communicable interface to the processor 210. In addition, when another communicable interface is selected from among the plurality of communicable interfaces in response to an interface control signal ICON that corresponds to a different electronic device 600, the interface controller 230 may switch the connection, from between the first selected communicable interface and the processor 210, to between the later selected communicable interface and the processor 210.

The interface controller 230 may receive resource information IRSC from the external electronic device 600 through the communication interface circuit 500, and may transmit the resource signal RSC to the processor 210.

The vehicle information collection circuit 250 may collect information from any and all units or devices internal to the vehicle that generates or collects information, and may transmit the collected information to the processor 210. The processor 210 may apply or utilize any collected information acquired from the vehicle information collection circuit 250, including using the collected information to determine a reason for and information regarding the fault.

For example, the vehicle information collection circuit 250 may collect various kinds of information about the smart vehicle through smart vehicle system 10, such as information about whether the smart vehicle is currently driving or operating, vehicle trajectory information, routine inspection information, fault diagnosis information, consumables management information, operation and management information, operational environment information, vehicle type information, as non-limiting illustrations.

The security processor 260 may perform security processing with respect to the communicable interface, selected from among a plurality of communicable interfaces, by the processor 210. When the smart vehicle system 10 communicates with an external electronic device 600, this communication between the smart vehicle system 10 and the external electronic device 600 will be defined as Vehicle-to-everything (V2X) communication. V2X communication may also be represented or described by any one of Vehicle-to-Infrastructure (V2I) communication, Vehicle-to-Vehicle (V2V) communication, Vehicle-to-Pedestrian (V2P) communication, Vehicle-to-Device (V2D) communication, and Vehicle-to-Grid (V2G) communication, as non-limiting examples.

In accordance with embodiments disclosed herein, V2X communication may be used to transmit Forward Collision Warning (FCW) information, Lane Change Warning (LCW) information, Blind Spot Warning (BSW) information, Intersection Movement Assist (IMA) information, Emergency Vehicle Approaching (EVA) information, and platooning information, as non-limiting examples. In such embodiments, the above-mentioned information for use in V2X communication may be transmitted and received in a manner sufficient to satisfy security requirements.

After receiving interface information needed to communicate with the electronic device 600 from the processor 210, the security processor 260 may process security information or data relating to the corresponding communicable interface in communication interface circuit 500. That is, the security processor 260 may analyze communicable interface information received from the processor 210, and may adaptively apply a security level to the analyzed information.

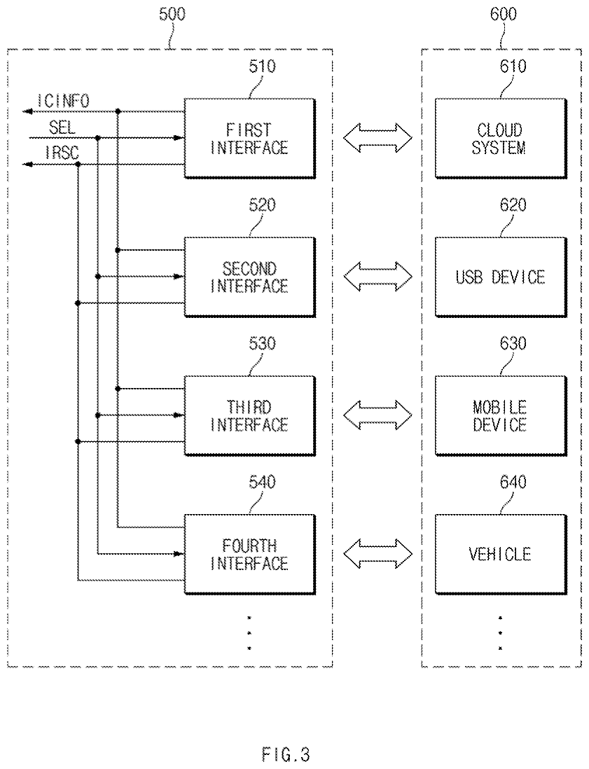

FIG. 3 is a block diagram illustrating a communication interface circuit 500 illustrated in FIG. 1.

Referring to FIG. 3, the communication interface circuit 500 may include a plurality of communicable interfaces, for example, a first interface 510, a second interface 520, a third interface 530, and a fourth interface 530.

The communication interface circuit 500 may transmit communication state information ICINFO, indicating a connection or communication state of each of the first to fourth interfaces 510˜540, to the interface controller 230. In addition, the communication interface circuit 500 may receive resource information IRSC from the external electronic device 600, and may transmit the received resource information IRSC to the interface controller 230. The communication interface circuit 500 may select any one of the first to fourth interfaces 510˜540 in response to a selection signal SEL received from the interface controller 230.

The external electronic device 600 may include a cloud system 610, a Universal Serial Bus (USB) device 620, a mobile device 630, and a vehicle 640, as non-limiting examples. The number of external electronic devices 600 is not limited to four, and may include one or more than one device. The vehicle 640 may refer to a peripheral vehicle located in an external region of the smart vehicle or smart vehicle system according to embodiments of the disclosure.

The communication interface circuit 500 may include a data exchange protocol used to communicate with electronic devices 600, and may allow the smart vehicle system 10 to be coupled or connected to any one or more of the electronic devices 600. For example, when the first interface 510 is selected, the communication interface circuit 500 may communicate with the external cloud system 610 through the selected first interface 510. When the first interface 510 communicates with the cloud system 610, the communication interface circuit 500 may use various applications, for example, an Advanced Driver Assistance System (ADAS), Telematics, etc.

In another example, when the second interface 520 is selected, the communication interface circuit 500 may communicate with the external USB device 620 using Universal Plug and Play (UPnP), CAN communication, etc.

In a further example, when the third interface 530 is selected, the communication interface circuit 500 may communicate with the external mobile device 630 using known communication methods or systems, such as Wi-Fi for instance. When the third interface 530 communicates with the USB device 620, the communication interface circuit 500 may use the applications such as the Advanced Driver Assistance System (ADAS) and the like.

In a yet further example, when the fourth interface 540 is selected, the communication interface circuit 500 may communicate with the external peripheral vehicle 640 using specific communication, methods or systems, such as Bluetooth, Wi-Fi, or the like.

The above-mentioned interface methods and systems utilized to connect the communication interface circuit 500 and the electronic devices 600 are merely examples, and the scope or spirit of categories and communication schemes of such interfaces are not limited thereto.

In a process or method of allocating priority information, the host 100 according to an embodiment may sequentially allocate priority information to the first to fourth interfaces 510 to 540. That is, the host 100 may sequentially allocate access priority information to the cloud system 610, the USB device 620, the mobile device 630, and the vehicle 640 from among the external electronic devices 600.

However, the scope or spirit of the present disclosure is not limited thereto, and the order of priority information may be changed as necessary or as desired.

In accordance with another embodiment, the host 100 may change priority information of the first to fourth interfaces 510˜540 in consideration of factors such as a communicable state of each of the first to fourth interfaces 510˜540, a bandwidth of the storage device 400, a bandwidth of the external electronic device 600, and data reliability, as non-limiting examples.

Although an embodiment of the present disclosure has exemplarily disclosed that any one of the first to fourth interfaces 510˜540 may be selected, the scope or spirit of the present disclosure is not limited thereto, and it should be noted that two or more communicable interfaces may also be selected as necessary or as desired.

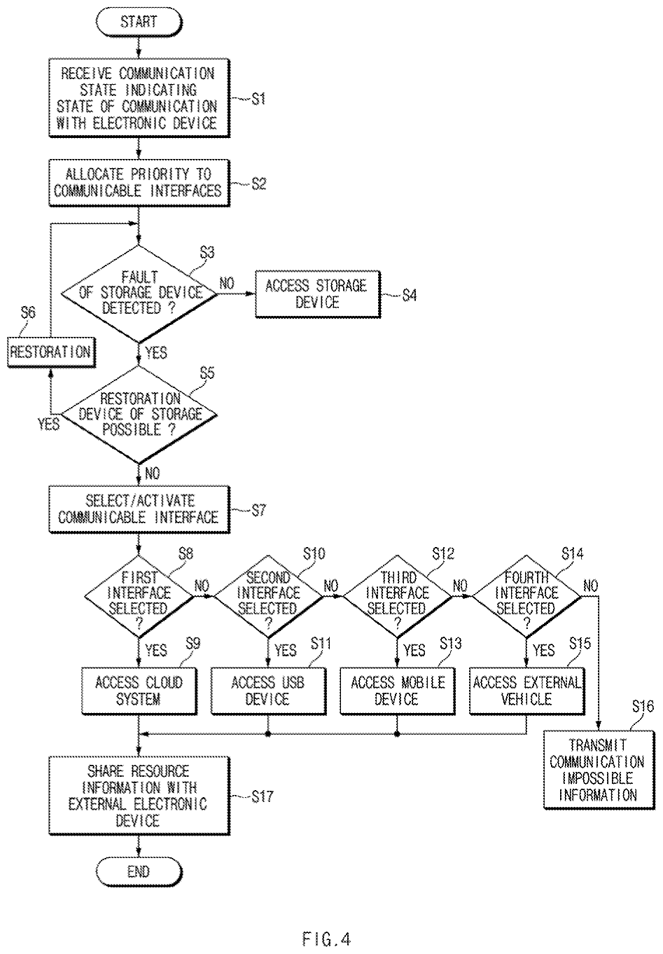

FIG. 4 is a flowchart illustrating a method of operating a smart vehicle with a smart vehicle system, such as smart vehicle system 10 shown in FIGS. 1-3. Operations of the smart vehicle system 10 according to an embodiment of the present disclosure will hereinafter be described with reference to FIG. 4.

Referring to FIG. 4, a communication interface circuit 500 may transmit communication state information ICINFO of first to fourth interfaces 510˜540 to the interface controller 230. The processor 210 may store communication state information CINFO received from the interface controller 230, and may transmit the stored information INFO to the host 100 (Step S1).

Thereafter, the host 100 may allocate priority information to communicable interfaces such as first to fourth interfaces 510˜540 in response to the received information INFO (Step S2). Assuming that each of the first to fourth interfaces 510˜540 are in a communicable state, the host 100 may transmit priority information, of the communicable first to fourth interfaces 510˜540, to the controller 200.

Subsequently, the fault detection circuit 220 may test the storage device 400 to detect an occurrence or a non-occurrence of a faulty operation in the storage device 400 (Step S3). If a faulty operation of the storage device 400 is not detected by the fault detection circuit 220, then the fault detection circuit 220 may access the storage device 400 for storing or reading information utilized to control or operate the smart vehicle system 10 (Step S4). In contrast, if a faulty operation of the storage device 400 is detected by the fault detection circuit 220, then the fault detection circuit 220 may activate or generate the detection signal DET and transmit the signal to the processor 210.

Subsequently, the processor 210 may determine whether the faulty state of the storage device 400 can be restored (Step S5). If it is possible to restore the faulty state of the storage device 400, through redundancy for example, the processor 210 may restore and cure the faulty state of the storage device 400 through a redundant operation (Step S6). In the alternative, if the faulty state of the storage device 400 cannot be cured through redundancy, the processor 210 may generate and transmit the interface control signal ICON to the interface controller 230.

Therefore, the interface controller 230 may select any one of the communicable first to fourth interfaces 510˜540 according to priority information. The selected communicable interface may be activated (Step S7).

For example, when the first interface 510 is selected in response to the control signal SEL from the interface controller 230 (Step S8), the smart vehicle system 10 may communicate with the cloud system 610 from among potential external electronic devices 600 (Step S9). In another example, when the second interface 520 is selected in response to the selection signal SEL of the interface controller 230 (Step S10), the smart vehicle system 10 may communicate with the USB device 620 from among the potential external electronic devices 600 (Step S11).

In a further example, when the third interface 530 is selected in response to the selection signal SEL of the interface controller 230 (Step S12), the smart vehicle system 10 may communicate with the mobile device 630 from among the potential external electronic devices 600 (Step S13). In a yet further example, when the fourth interface 540 is selected in response to the selection signal SEL of the interface controller 230 (Step S14), the smart vehicle system 10 may communicate with another external vehicle 640 from among the potential external electronic devices 600 (Step S15). When all the first to fourth interfaces 510˜540 are in a communication impossible state, the processor 210 may transmit information INFO about the communication impossible state to the host 100 (Step S16).

Thereafter, the communication interface circuit 500 may receive resource information IRSC from the external electronic devices 600 through the selected interface, and may transmit the received resource information IRSC to the interface controller 230. As a result, the processor 210 may store a resource signal RSC received from the interface controller 230 in the resource storage circuit 240, and may share resource information with the corresponding external electronic device 600 (Step S17).

As is apparent from the above description, the smart vehicle system and methods of operation according to embodiments of the present disclosure may increase driving stability, safety or reliability of a smart vehicle using a memory of an external electronic device when a reliability error or faulty operation occurs in the storage device of the smart vehicle.

Those skilled in the art will appreciate that the embodiments may be carried out in other specific ways than those set forth herein without departing from the spirit and essential characteristics of the disclosure. The above embodiments are therefore to be construed in all aspects as illustrative and not restrictive. The scope of the disclosure should be determined by the appended claims and their legal equivalents, not by the above description. Further, all changes coming within the meaning and equivalency range of the appended claims are intended to be embraced therein. In addition, it is obvious to those skilled in the art that claims that are not explicitly cited in each other in the appended claims may be presented in combination as an embodiment or included as a new claim by a subsequent amendment after the application is filed.

Although a number of illustrative embodiments have been described, it should be understood that numerous other modifications and embodiments can be devised by those skilled in the art that will fall within the spirit and scope of the principles of this disclosure. Particularly, numerous variations and modifications are possible in the component parts and/or arrangements which are within the scope of the disclosure, the drawings and the accompanying claims. In addition to variations and modifications in the component parts and/or arrangements, alternative uses will also be apparent to those skilled in the art.

What is claimed is:

1. A smart vehicle system comprising:
a storage device;
a host configured to receive a communication state information, store the received communication state information, and transmit a priority information of a communicable interface in response to the communication state information;
a controller configured to select the communicable interface in response to the priority information, when a fault in the storage device is detected; and
a communication interface circuit configured to include a plurality of communicable interfaces and to communicate with an external electronic device through the communicable interface selected by the controller,
wherein the controller is further configured to receive a resource information from the external electronic device through the communication interface circuit, store the received resource information, and control an operation of a smart vehicle using the stored resource information.

2. The smart vehicle system according to claim 1, wherein the host is configured to sequentially allocate priority information to the plurality of communicable interfaces.

3. The smart vehicle system according to claim 1, wherein the host is further configured to allocate priority information to the plurality of communicable interfaces in response to a communication state information of at least one of the plurality of interfaces, a bandwidth of the storage device, a bandwidth of the electronic device, and degree of data reliability.

4. The smart vehicle system according to claim 1, further comprising:
a storage interface circuit coupled to the storage device and to the controller.

5. The smart vehicle system according to claim 1, wherein the controller is further configured to receive a communication state information, indicating a state of communication with the external electronic device, from the communication interface circuit, and to transmit the communication state information to the host.

6. The smart vehicle system according to claim 1, wherein the controller comprises:
a processor configured to receive the priority information from the host, and to generate an interface control signal for selecting any one of the plurality of communicable interfaces;
a fault detection circuit configured to detect a fault in the storage device; and
an interface controller configured to generate a selection signal for selecting a communicable interface corresponding to the interface control signal.

7. The smart vehicle system according to claim 6, wherein the processor is configured to receive the communication state information from the interface controller, to store the communication state information, and to transmit the communication state information to the host.

8. The smart vehicle system according to claim 6, wherein:
the processor is configured to transmit the interface control signal to the interface controller when the fault detection circuit detects a fault in the storage device.

9. The smart vehicle system according to claim 6, wherein the fault detection circuit is configured to detect a hardware fault of the storage device.

10. The smart vehicle system according to claim 6, wherein the fault detection circuit is configured to detect a software error of the storage device.

11. The smart vehicle system according to claim 6, wherein the fault detection circuit includes a Built-In Self-Test (BIST) circuit.

12. The smart vehicle system according to claim 6, wherein the interface controller is configured to receive the communication state information of the communicable interface, and to transmit the communication state information to the processor.

13. The smart vehicle system according to claim 6, wherein the interface controller is configured to receive the resource information through the communication interface circuit, and to transmit the resource information to the processor.

14. The smart vehicle system according to claim 6, wherein the controller further comprises:
a resource storage circuit configured to store the resource information.

15. The smart vehicle system according to claim 6, wherein the controller further comprises:
a vehicle information collection circuit configured to collect information about respective units contained in the vehicle, and to transmit the collected information to the processor.

16. The smart vehicle system according to claim 6, wherein the controller further comprises:
a security processor configured to perform security processing for the communicable interface selected by the processor from among the plurality of interfaces.

17. The smart vehicle system according to claim 1, wherein the storage device is implemented as a plurality of storage devices, and wherein each of the plurality of storage devices may be coupled to the controller through the storage interface circuit.

18. The smart vehicle system according to claim 1, wherein the storage device includes at least one of a volatile memory and a non-volatile memory.

19. The smart vehicle system according to claim 1, wherein the plurality of communicable interfaces includes different types of interfaces.

20. The smart vehicle system according to claim 1, wherein the communication interface circuit is configured to receive the resource information from the external electronic device through a communicable interface selected from among the plurality of communicable interfaces, and to transmit the resource information to the controller.
